(19) United States
(12) Patent Application Publication
(10) Pub. No.: US 2005/0089159 A1
(43) Pub. Date: Apr. 28, 2005

(54) Housing or housing part and method for producing a housing or housing part, and tool for carrying out said method

(76) Inventor: Cornelia Schrack, Ulm (DE)

Correspondence Address: BELL, BOYD & LLOYD, LLC, P. O. BOX 1135, CHICAGO, IL, 60690-1135, US

(21) Appl. No.: 10/505,539

(22) PCT Filed: Feb. 19, 2003
(86) PCT No.: PCT/DE03/00531

(30) Foreign Application Priority Data
Feb. 21, 2002 (DE) 102 07 289.2

(51) Int. Cl. H04M 1/00; H04M 9/00

(52) U.S. Cl. 379/433.13

(57) ABSTRACT

A faceplate or a housing is provided for a mobile telecommunication terminal, which includes a first assembly, respectively a slotted assembly having a transparent area, and a second assembly, respectively a housing assembly, whereby the first assembly and the second assembly are or can be linked by ultrasonic welding.

### BACKGROUND OF THE INVENTION

The present invention relates to a housing or housing part which includes a first and a second assembly, together with a manufacturing method for manufacturing a housing or housing part of this type.

Housings or housing parts of this type are known within the prior art. Thus, for example, housing parts for mobile telephones are known, so-called faceplates, which are constructed of a housing assembly and a window assembly incorporating a transparent area. To manufacture the complete faceplate, the window assembly and the housing assembly are glued together. Since the gluing operation is complicated to control, it is difficult with the gluing method to achieve a joint of uniform quality between the housing parts. This can lead, for example, to great variation in the strength of the joint from one faceplate to another. In particular, the joint between the components can be non-uniform, which means that it can be relatively weak in one area and stronger in other areas. In addition, the application of the adhesive calls for an additional production step, which makes the manufacture of such housing parts more expensive and complicated. Since the adhesive generally has a different chemical composition from that of the housing parts, complications can arise with faceplates manufactured using adhesive techniques, for example when the temperature fluctuates and in environments which contain solvents and/or are aggressive (e.g., moisture, UV radiation), because in these cases the adhesive and the housing materials may behave differently.

Furthermore, the Japanese patent application JP10021666-A discloses details of multi-part plastic housings for magnetic storage media (floppy disks). The plastic housings consist of two parts which are joined together through ultrasonic welding. In this case, one of the components incorporates conical bumps, while circular depressions are formed in the other component. When the two components are being joined, the conical bumps on the one part project into the circular depressions in the other, and the ultrasonic welding process is then started. The joint between the two assemblies is made at the points of contact between the conical bumps and the circular depressions. The disadvantage of this housing is the very inhomogeneous joint between the two housing parts, because the bumps and depressions respectively are located only at the corners of the housing, where there are relatively strong bonding points, whereas between these bonding points the two housing parts are not bonded at all. For this reason such housings cannot be subject to any significant loading, in particular not to loads from different sides, because they can be damaged, for example by a load or force which is applied not directly in the region of a weld point, due to the assemblies not being joined over long areas.

### SUMMARY OF THE INVENTION

At least some of the problems, arising from the prior art as described above, are solved by a faceplate or a housing for a mobile telecommunication terminal having a first assembly, in particular a window assembly which incorporates a transparent area, and a second assembly, in particular a housing assembly, where the first assembly and the second assembly are or can be joined together by using ultrasound to weld them.

In order to join together a faceplate or a housing for a mobile telecommunication terminal from two assemblies, using the method of ultrasonic welding known per se (see, for example, Heinrich Kuttruff, “Physik und Technik des Ultraschalls” [Physics and technology of ultrasound], S. Hirzel Verlag, Stuttgart, page 373 ff), the two assemblies are first brought into contact. After this, the faceplate or housing is inserted between a so-called sonotrode and the anvil of an ultrasonic welding system, and ultrasound waves are injected into the faceplate or housing through the sonotrode. The ultrasound heats the assemblies at their points of contact and, at least locally, melts them and in this way joins them.

Compared to the adhesive technique used until now for the manufacture of faceplates or housings for mobile telecommunication terminals, the ultrasonic welding method has the advantage that one less processing step is required. The application of adhesive is not required. This makes the manufacturing procedure simpler, and also easier to automate. In addition, the process of applying the adhesive is inherently liable to cause problems, because uneven application of the adhesive results in the joint between the assemblies of the faceplate or the housing being very inhomogeneous and, in some cases, very easily broken at certain weak points.

The use of an ultrasonic welding procedure for joining the two assemblies permits a much more secure and homogeneous joint to be made, because the joint is ultimately defined by the places at which the two assemblies of the faceplate or housing touch each other. These bonding points are determined by the geometry of the two assemblies which, for example, can be very precisely specified and controlled when injection molded plastic parts are used, due to the refined manufacturing techniques which are available.

The joint between the two assemblies can be further improved by the integration of so-called energy directors into one or both of the assemblies. The term energy director usually refers to a bump which is arranged on an assembly in such a way that, when the assemblies which are to be joined are brought together, the contact between the assemblies prior to ultrasonic welding is preferably at the top of the energy director. One of the functions of an energy director is to define better the start region for the ultrasonic welding, and hence to improve the quality of the joint between the two assemblies. An energy director will, for example, have sound guiding properties which feed the ultrasound energy, injected into the assembly concerned, into the upper regions of the structure (e.g. the tip or top edge), and concentrate it there. As a result, during welding, the process of heating to the molten state starts preferentially in these regions.

Such energy directors can be formed at individual points on an assembly but it is also possible, for example, for a rib-shaped or ridge-type raised area made up of energy directors to form a raised structure with a closed contour. Such a closed raised structure could be appropriate, for example, if the joint between two assemblies is to be sealed, for example dust- or water-tight. This form of embodiment can be particularly advantageous if one of the assemblies has an opening and the contiguous rib-shaped or raised structure, as appropriate, is arranged around this opening. When the first assembly, which has the opening, is brought together with a second assembly, which covers the opening, then in this case the joint between the two assemblies produced by ultrasonic welding runs along the ring-shaped raise, and hence seals the two assemblies, and thus the opening. Alternatively, it is also possible, for example, that the ring-shaped raise is formed not on the first assembly but in a corresponding position on the second assembly. After the two assemblies have been joined using ultrasound, there is then an equivalent sealed joint.

As mentioned above, energy directors can be formed as lengthwise raised structures, so-called ribs. Furthermore, it is possible for the ribs to be reduced, in their lengthwise direction, to approximately conical or pyramid-shaped bumps, so-called pins. This may be necessary, for example, if there is no space for lengthwise ribs due to the complex geometry or fine-structured design of the assemblies for a housing. Furthermore, it may be the case in some circumstances that the ribs would change the external appearance of the housing. So, on a housing which consists of several assemblies, areas which are joined directly with ribs may have different visual properties than those of housing parts which are not directly joined. This can be the case, for example, with housing materials and areas which are optically transparent or semi-transparent. As a result of a direct joint between two assemblies along the ribs these areas may appear optically more transparent, for example, than areas which are not directly joined. This effect can be reduced or avoided, for example, by reducing the ribs to individual pins.

In the context of this description, a rib should be understood as a lengthwise raised area on a surface, in which the greatest lateral dimension of the raised area is significantly larger than the smallest lateral dimension of the raised area. In particular, the greatest lateral dimension should be greater by more than a factor of 2 than the smallest lateral dimension. The term pin is to be understood as a raised area on a surface for which the greatest lateral dimension and the smallest lateral dimension are of the same order of magnitude; in particular, having a maximum ratio of 2:1. Here, the term lateral dimension is to be understood as the dimension of the raised area parallel to the surface on which it is located.

At least some of the problems from the prior art cited above, by way of example, are resolved in addition by a set for the manufacture of a faceplate or a housing for a mobile telecommunication device having a first assembly, in particular a window assembly incorporating a transparent area, and a second assembly, in particular a housing assembly, in which the first assembly and the second assembly can be joined together by welding using ultrasound.

In addition, at least some of the problems from the prior art cited above, by way of example, are resolved by a method for the manufacture of a faceplate or a housing for a mobile telecommunication device having a first assembly, in particular a window assembly incorporating a transparent area, and a second assembly, in particular a housing assembly, in which the first assembly and the second assembly can be joined together in a predefined final position by welding using ultrasound.

At least some of the problems from the prior art cited above, by way of example, are also resolved by a housing assembly which incorporates at least one pin or at least one suitable hole into which a pin can fit and, in addition, at least one rib or at least one suitable groove into which a rib can fit, whereby the housing assembly is joined or can be joined to a second housing assembly through welding by ultrasound making use of the pin or the hole and making use of the rib or the groove.

In addition, at least some of the problems from the prior art cited above can be resolved by an apparatus, in particular an injection molding tool, which is designed for the manufacture of the housing assembly described in the previous paragraph.

By using a combination of several joining elements, such as a rib and a pin, the strength of the joint between two housing assemblies of a housing or housing part is further increased. In this way it is possible, on the one hand, to increase the absolute strength of the joint and, on the other hand, it results in a joint which can be subject to more varied loads. Since the process of welding the housing assemblies by ultrasonic welding generally starts at the ribs and/or pins which have been formed for the purpose of ultrasonic welding, a larger number of such joining elements, distributed across the assemblies, will result in a more homogeneous joint between the two assemblies, which makes the joint capable of more varied loading, and more robust.

The strength and homogeneity of a joint between two housing assemblies to form a housing or housing part can also be improved by the formation of a so-called energy director in one of the assemblies, and a structure in the other assembly with a form which is at least partially complementary to the energy director. When this is done, the energy director and the structure which complements it, or at least sections of them, must touch each other when the two housing assemblies are brought into the predetermined final position for ultrasonic welding. Thus, one housing assembly could, for example, have a pin and the other assembly a hole suitable for accommodating the pin, into which the pin projects at least partially when in the predetermined final position, and whereby in addition parts of the surface of the pin and parts of the surface of the hole are in contact. One result of such a design is an increase in the surface area over which the ultrasonic welding begins and/or occurs, compared to the situation in which only a pin is present, with no corresponding hole. Secondly, making the assemblies in this form makes it possible to substantially simplify the positioning of the assemblies prior to ultrasonic welding, because a precise position of the two assemblies prior to ultrasonic welding is defined by the “engagement” of the energy director on the one assembly into the corresponding structure, to which it is at least partially complementary, on the other assembly. In this way it is possible to reduce the expenditure on equipment and work for bringing the two assemblies into the predefined final position for ultrasonic welding, which simplifies the assembly process for the assemblies.

In a similar way to that illustrated, by way of example, in the preceding paragraph for pins and corresponding holes, it is also possible through the use of ultrasound to improve and simplify the joint if one of the two assemblies incorporates a lengthwise rib while the other assembly incorporates a groove into which the rib fits, whereby when the assemblies are in the predefined final position prior to the ultrasonic welding operation the rib fits at least partly into the groove and at least parts of the surfaces of the rib and the groove touch each other. By comparison with a pin and an associated hole, a rib and an associated groove generally have a substantially greater contact area which, after ultrasonic welding, results in a joint which is capable of bearing substantially more load. Also, the use of a rib on one assembly and a corresponding groove in the other assembly, for example, allows the positioning of the two components prior to ultrasonic welding to be simplified in an analogous way to the use of pins and associated holes.

It is of particular advantage to combine at least one pin or at least one suitable hole into which a pin will fit with at least one rib or at least one groove designed for a rib to fit into, because this gives an advantageous combination of the strength of the joint, positional accuracy of the two components relative to each other prior to ultrasonic welding, and the ability of the joint to withstand various loads. In general, the positional accuracy when the assemblies are brought together prior to being bonded, and the homogeneity and load-bearing ability of the ultrasonic welded joint, increase with the number of the structures used and their dimensions. Of particular advantage is the use of several ribs or grooves and/or several pins or holes, as applicable. Ribs/grooves at various suitable places on the assemblies make for a very strong joint, while pins/holes can be formed at other points which are, for example, not suitable for ribs/grooves because their shapes are, for example, too narrow, delicate and/or fine-structured.

Some of the problems from the prior art cited above, by way of example, are also solved in accordance with the present invention by a housing part or housing having a first assembly and a second assembly, where the first and the second assembly are joined or can be joined in a predefined final position by welding with ultrasound and where the housing part also incorporates at least one pin on one of the assemblies and on the other assembly at least one hole, at least some areas of which have a shape complementary to the opposing pin or pins in the predefined final position, and where the housing part also incorporates at least one rib on one of the assemblies and on the other assembly at least one groove, at least some areas of which have a shape complementary to the opposing rib or ribs in the predefined final position.

The use of at least one pin in an assembly used in the manufacture of a housing or housing part, and a corresponding hole in a second assembly required for the manufacture of the housing or housing part, and the use at the same time of at least one rib in one of the assemblies and a corresponding groove in the other assembly, ensures a particularly homogenous and durable joint between the two assemblies after they are bonded by ultrasonic welding. Furthermore, such a construction results in a simplification of the positioning of the two assemblies prior to the actual ultrasonic welding process, because the rib and the associated groove, or the pin and associated hole, as applicable, ‘engage’ with each other. In the “engaged” position, only minimal movement of the two assemblies is still possible, at least parallel to the surfaces along which they are joined.

In a further embodiment of the present invention, there may be more than one rib/groove combination and/or more than one pin/hole combination on the assemblies. An advantage of this further form of embodiment is that each additional such structure increases the positioning accuracy of the two assemblies prior to ultrasonic welding, and the homogeneity and strength of the joint after welding.

The rib/groove and pin/hole structures described above can, in addition, be combined with the rib-shaped on pin-shaped raised areas on the surface of one of the assemblies, the energy directors already mentioned above. Such energy directors do not require structures with a complementary shape on the other of the two assemblies concerned. During the ultrasonic welding process, these raised areas are bonded to the areas which they touch on the other assembly concerned. These structures effect a further strengthening and homogenization of the joint between two assemblies to form a housing or housing part.

It can be particularly advantageous if such energy directors are combined with the pin/hole or rib/groove structures in such a way that, for example, several pins are linked together by energy directors. Furthermore, pins or holes and ribs/grooves can also be linked together in this way.

In a further embodiment of the present invention, a first assembly of a housing or housing part incorporates an opening which is overlapped by at least one area of a second assembly of the housing or housing part. If the two assemblies are brought into the predefined final position for ultrasonic welding, a bonding area is produced within which the surface of the one assembly is opposite the surface of the other assembly. It is advantageous if the above-mentioned rib/groove and pin/hole structures are formed on this bonding surface. In addition, one of the assemblies can, for example, incorporate raised structures which, for example, in the predefined final position run in a closed line round the opening in the first assembly. In this way the opening in the first assembly can be given a cover which, after the ultrasonic welding, is sealed, for example water- or dust-tight. In addition, the second assembly can incorporate a transparent area, at least in the region of the opening in the first assembly (in the predefined final position).

In addition, a first assembly, which can be joined to a second assembly by ultrasonic welding, can have a depression formed in it which is, at least in places, complementary to the external form of the second assembly. It is possible in this way to further increase the positioning accuracy of the two assemblies prior to ultrasonic welding because when the second assembly is brought into the predefined final position at least parts of it are inserted into depressions in the first assembly.

A housing part in accordance with the present invention can be formed, for example, as the faceplate for a mobile telecommunication device, in particular a mobile phone. Further, a first assembly for this faceplate can be a housing part which incorporates openings for keypad keys and a display unit, while the second assembly can be an area incorporating a transparent window assembly, with which one or more openings in the first assembly, in particular for the display unit, can be covered. Since mobile telecommunication devices, in particular mobile phones but also Personal Digital Assistants with mobile radiocommunication capabilities or other data processing equipment with mobile radiocommunication capabilities, are frequently carried about by their users, they are subject to particularly severe stresses. For this reason robust housings, capable of withstanding stresses, are indispensable for these devices. Such housings or housing parts can with advantage be manufactured by the above-mentioned methods, through ultrasonic welding and making use of pin/hole and rib/groove structures in the assemblies for these housings. Because these devices are consumer devices, which are also offered in the medium and lower price brackets, attention must be given to the efficiency of the production process. Here, the ultrasonic welding process specified above, using pins/holes and ribs/grooves, offers the advantage compared, for example, to an adhesive method, that it is possible to save the assembly step of applying an adhesive. Furthermore, the use of pin/hole and rib/groove joints ensures a high positioning accuracy when the assemblies are brought together in the predefined final position prior to their ultrasonic welding, which results in a simple but high-quality assembly process in the manufacture of such faceplates.

Furthermore, some of the problems from the prior art cited above, by way of example, are also solved by a set for the manufacture of a housing part or housing, having a first assembly and a second assembly, where the first and the second assembly can be bonded in a predefined final position by welding through ultrasound, and where the housing part incorporates at least one pin on one of the assemblies and in the other assembly at least one hole which has a shape complementary to the opposing pin or pins in the predefined final position, and where the housing part also incorporates at least one rib on one of the assemblies and in the other assembly at least one groove which has a shape complementary to the opposing rib or ribs in the predefined final position.

Furthermore, some of the problems from the prior art cited above, by way of example, are solved by a method for the manufacture of a housing part or housing, having a first and a second assembly, where the first and the second assembly can be bonded in a predefined final position by welding through ultrasound, and where the housing part incorporates at least one pin on one of the assemblies and in the other assembly at least one hole which has a shape complementary to the opposing pin or pins in the predefined final position, and where the housing part also incorporates at least one rib on one of the assemblies and in the other assembly at least one groove which has a shape complementary to the opposing rib or ribs in the predefined final position.

The present invention covers, in addition, an ultrasonic welding facility, for the manufacture of a housing or housing part in accordance with the method described in the preceding paragraph, which has an ultrasound source, an anvil for holding the housing or housing part, and a sonotrode for injecting the ultrasound into the housing or housing part, where the sonotrode is constructed in such a way that the delivery of the ultrasonic energy to all the areas intended for welding by ultrasound is essentially uniform. In order to achieve this it is advantageous if the surface of the sonotrode which is in contact with the housing or housing part during ultrasonic welding has a contour which corresponds to the contour of the area of the housing or housing part which is being welded by the method described in the preceding paragraph, through ultrasound.

This region, in which the welding of the two assemblies of the housing is effected, may be a simple contiguous area, for example in the case of a self-contained weld seam or an individual weld point. However, the weld region can be made up of several unlinked sub-regions, for example in the case of several independent weld points. Such a choice for the shape of the sonotrode's contact area is advantageous because in this way the sonic energy which is injected is delivered only to regions which are relevant for the welding process, and no sonic energy is delivered to the regions where welding is not intended. The welding facility can then be operated in an energy-saving manner and any unwanted damage to the housing or housing part, due to misdirected sonic energy, can be avoided.

Some of the problems from the prior art cited above, by way of example, are also solved by an apparatus, in particular an injection molding tool, which is designed for the manufacture of one of the assemblies described in the preceding twelve paragraphs.

Additional features and advantages of the present invention are described in, and will be apparent from, the following detailed description of the invention and the figures.

Additional features and advantages of the present invention are described in, and will be apparent from, the following Detailed Description of the Invention and the figures.

### BRIEF DESCRIPTION OF THE FIGURES

FIG. 1 shows a front view of a window assembly and a housing assembly for a faceplate in accordance with the present invention for a mobile phones.

FIG. 2 shows a rear view of a window assembly and a housing assembly for a mobile phones.

FIG. 3a shows a front view of a faceplate in accordance with the present invention for a mobile phone, consisting of a window assembly and a housing assembly, in the assembled state.

FIG. 3b shows a side view along the section line A₁-A₁ from FIG. 3a.

FIG. 3c shows an enlargement of the area marked Y in FIG. 3b.

FIG. 4a shows a front view of the window assembly.

FIG. 4b shows a side view of the window assembly.

FIG. 4c shows a rear view of the window assembly.

FIG. 5a shows a side view along the section line A-A in FIG. 4c.

FIG. 5b shows a side view along the section line B-B in FIG. 4c.

FIG. 5c shows a enlargement of the area Z in FIG. 4c.

### DETAILED DESCRIPTION OF THE INVENTION

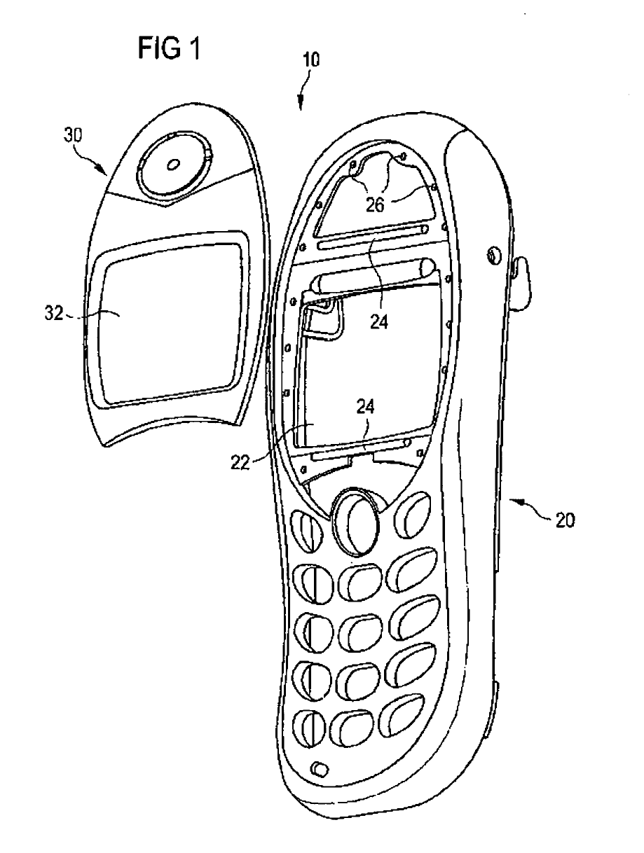

FIG. 1 illustrates two assemblies 20, 30 in accordance with the present invention, for a mobile phone faceplate 10 also in accordance with the present invention. The complete housing of the mobile telephone consists of the faceplate 10 and a base plate, which is not shown. The faceplate consists of a housing assembly 20 which has openings 21 for the keys required to operate the mobile phone. For the sake of clarity, not all of these openings 21 have been identified by a reference character. In addition, the housing assembly 20 has an opening 22 for viewing the display unit. Above and beneath the opening for the display unit 22, the housing assembly has rib-shaped raised areas 24. Also shown are some holes 26. Here again, the holes 26 shown in FIG. 1 have not all been identified by a reference character, to maintain the clarity of the drawing. FIG. 1 also shows the window assembly 30 in the faceplate 10, which incorporates a transparent area 32.

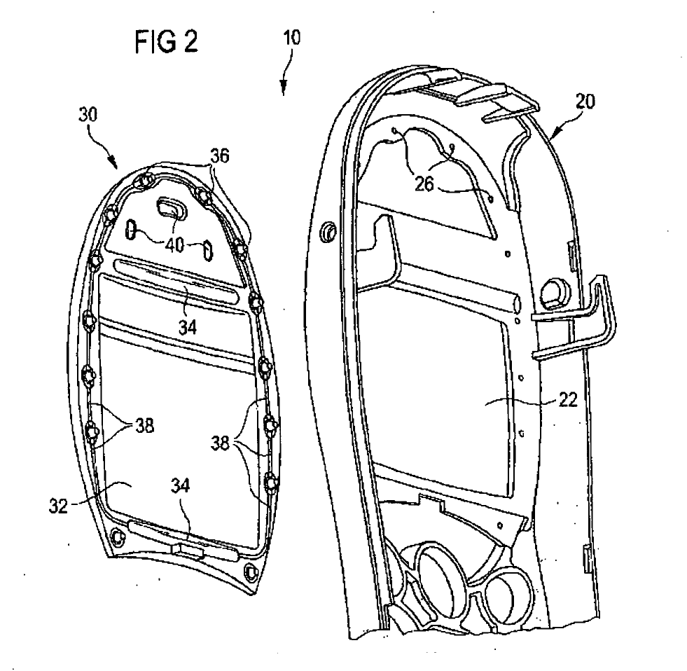

FIG. 2 shows a rear view of the window assembly 30 and housing assembly 20 for the mobile phone faceplate 10. In this, it is possible to recognize the holes 26 in the housing assembly 20 together with the open area 22 necessary for the display unit to be seen. The view of the rear side of the window module 30 shows, in addition to the transparent area 32, depressions or grooves 34 which have shapes which, at least in some places, are complementary to the ribs 24 on the housing assembly 20. Also shown are pins 36 which have shapes which, at least in some places, are complementary to the shapes of the holes 26 on the housing assembly 20. For reasons of clarity, the pins 36 shown also have not all been marked by a reference character. In addition, rib-shaped raised areas 38, so-called energy directors, are formed on the window assembly 30. The housing assembly 20 does not have any complementary structures corresponding to these energy directors 38. Together with some of the pins 36 and the grooves 34, the energy directors 38 form a self-contained structure.

When the window assembly 30 is brought together with the housing assembly 20, the pins 34 penetrate at least partially into the holes 26, while the ribs 24 penetrate at least partially into the grooves 34. In doing so, parts of the surfaces of the pins 36 make contact with parts of the surfaces of the holes 26, and parts of the surfaces of the ribs 24 make contact with parts of the surfaces of the grooves 34. After the assemblies 20, 30 have been brought together, ultrasound is injected into the mated assemblies via an ultrasound electrode, in an ultrasonic welding facility which is not shown. Starting with the contact areas of the pins 36 and the holes 26 together with the ribs 24 and the grooves 34, the window assembly 30 and the housing assembly 20 then fuse together, at least along sections. As a result of the melting of the joining structures 24, 26, 34, 36, the window assembly 30 and the housing assembly 20 come slightly closer together during the ultrasonic welding operation. After some time at the latest, the energy directors 38 on the window assembly 30 come into contact with areas on the housing assembly 20, whereupon these places also form a joint. This leads to the housing assembly 20 and the window assembly 30 moving yet closer together, until the point when the ultrasonic welding has produced a closed joint.

In this way a joint is produced, between the window assembly 30 and the housing assembly 20, which is dust-tight and, at least within limits, water-tight. The numerous combinations of pins 36 and holes 26, and of ribs 34 and grooves 24, result in a joint between the two assemblies which is very strong and can withstand a variety of stresses. Here, the combinations of rib 34 and groove 24, ensure in particular, the fundamental high strength of the joint, while the numerous combinations of pin 36 and hole 26 ensure the homogeneity of the joint and the positioning accuracy during assembly.

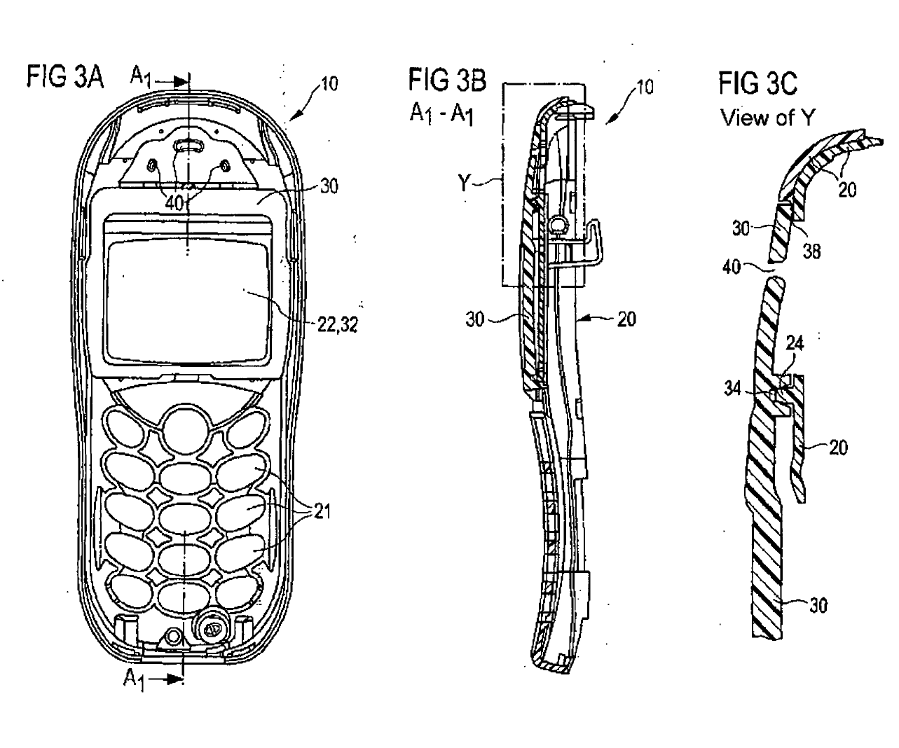

FIG. 3a shows the front view of the assembled faceplate 10. In this can be seen the housing assembly 20 and the window assembly 30. In addition, FIG. 3a shows the openings for the keyboard 21 and the opening for viewing the display unit 22, together with the transparent area of the window assembly 32. In addition, in the window assembly 30 can be seen the openings 40, which are located in the region of the mobile phone's loudspeaker and which facilitate the passage of sound through the housing.

FIG. 3b shows a cross-section through the faceplate shown in FIG. 3a along the section line A1-A1. Here again, the housing assembly 20 and the window assembly 30 can be recognized.

FIG. 3c shows an enlargement of the area of the faceplate indicated by Y in FIG. 3b. In this, parts of the window assembly 30 and the housing assembly again can be recognized. Also shown is one of the sound openings 40 together with the energy director 38 which runs along the perimeter of the window assembly 30. In the middle can be seen the rib 24 which runs above the window area of the housing module 20, which fits into the groove 34 in the window assembly 30, and which has a complementary shape.

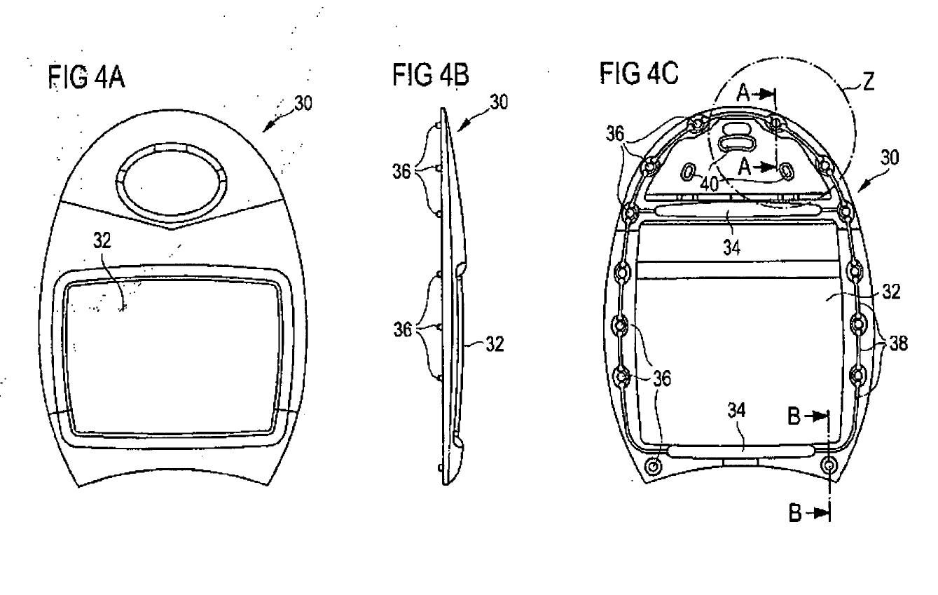

FIG. 4a shows a front view of the window assembly 30, with the area 32 which is constructed transparently. In FIG. 4b can be seen a side view of the window assembly 30 with the transparent area 32. In this side view, some of the individual pins 36 which are located on the perimeter of the window assembly 30 can be recognized.

FIG. 4c shows the rear view of the window assembly 30 with the transparent area 32. In particular, the pins 36 and the grooves 34 can be identified. Here, some of pins 36 or grooves 34 are, as already described for FIG. 2, linked by energy directors 38, and together form a self-contained structure. From FIG. 4c it is also possible to see how a sonotrode, suitable for ultrasonically welding the window assembly 30 to the housing assembly 20, could advantageously appear. The region to be welded essentially stretches, as can be seen from the line of the energy directors 38, pins 36 and grooves 34, along the edge of the window assembly 30, with a crosswise joint which runs from the left edge of the window assembly 30 to the right edge, via the rib 34 above the transparent area 32. The outer contour of that part of the surface of the sonotrode which is in contact with the faceplate thus corresponds essentially with the contour of the window assembly 30. In addition, the sonotrode can be constructed in such a way that it makes no direct contact with the faceplate in the region of the window 32 and in the D-shaped area which has the sound openings 40, which is formed above the window and above the groove 34 which is located there. In this situation, it is possible that the contour of the contact area on the sonotrode follows only approximately the contours of the window assembly 30 and the window 32, and the D-shaped area above the window 32. What is important is that the shape of the sonotrode is matched to the geometry of the weld joint.

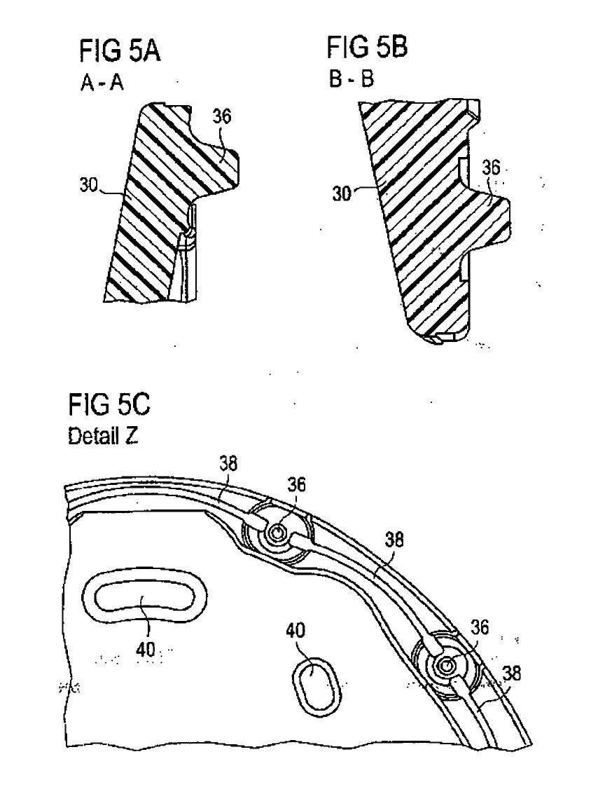

FIG. 5a shows a cross-section through a pin 36 on the window assembly 30, along the cross-section line A-A in FIG. 4c. In this it is possible to recognize, in particular, the truncated conical shape of the pin 36.

FIG. 5b shows a cross-section through a pin 36 on the window assembly 30, along the section line B-B in FIG. 4c. This pin 36 also has a truncated conical shape.

FIG. 5c shows an enlargement of the area of the window assembly 30 which is marked Z in FIG. 4c. It is possible to recognize, in particular, pins 36 which are linked via energy directors 38. Also shown are two of the sound openings 40.

The present invention sets out the possibility of manufacturing a faceplate or a housing for a mobile telecommunication device through ultrasonic welding. Also presented is a possibility for manufacturing a housing or housing part by ultrasonic welding, whereby a very strong joint can be produced by incorporating into the shape of individual assemblies of the housing or housing part either pins and complementary holes, or ribs and complementary grooves, as appropriate. In addition, incorporating structures of this type into the shape leads to a simplified method of manufacturing through ultrasonic welding, because by engaging the structures into each other it is easy to bring the various assemblies into their correct positions prior to welding.

Although the present invention as been described with reference to specific embodiments, those of skill in the art would recognize that changes may be made thereto without departing from the spirit and scope of the present invention as set forth in the hereafter appended claims.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-11. (canceled)

12. A faceplate for a mobile telecommunication device, comprising:
a first assembly; and
a second assembly;
wherein in the first assembly and the second assembly are joined together using ultrasonic welding.

13. A faceplate for a mobile telecommunication device as claimed in claim 12, wherein the first assembly is a window assembly incorporating a transparent area.

14. An apparatus for manufacturing a faceplate for a mobile telecommunication device, wherein the faceplate includes first and second assemblies, comprising parts for joining together the first assembly and the second assembly using ultrasonic welding.

15. An apparatus for manufacturing a faceplate for a mobile telecommunication device as claimed in claim 14, wherein the first assembly is formed as a window assembly incorporating a transparent area.

16. A method for producing a faceplate for a mobile telecommunication device, comprising:
providing a first assembly;
providing a second assembly; and
joining together the first assembly and the second assembly in a predefined final position using ultrasonic welding.

17. A method for producing a faceplate for a mobile telecommunication device as claimed in claim 16, wherein the first assembly is formed as a window assembly incorporating a transparent area.

18. A housing assembly for a faceplate for a mobile telecommunication device, comprising:
one of at least one pin and at least one receptacle part suitable for a pin to fit in to; and
one of at least one rib and at least one groove part suitable for a rib to fit in to;
wherein the housing assembly may be joined to a second housing assembly using ultrasonic welding making use of the respective at least one pin, receptacle part, rib and grooved part.

19. An injection molding apparatus for manufacturing a housing assembly, comprising parts for forming on the housing assembly one of at least one pin and at least one receptacle part suitable for a pin to fit in to, and for forming on the housing assembly one of at least one rib and at least one groove part suitable for a rib to fit in to, wherein the housing assembly thereafter may be joined to a second housing assembly using ultrasonic welding making use of the respective at least one pin, receptacle part, rib and grooved part.

20. A method for manufacturing a housing assembly, comprising:
forming on the housing assembly one of at least one pin and at least one receptacle part suitable for a pin to fit in to; and
forming on the housing assembly one of at least one rib and at least one groove part suitable for a rib to fit in to, wherein the housing assembly thereafter may be joined to a second housing assembly using ultrasonic welding making use of the respective at least one pin, receptacle part, rib and grooved part.

21. A housing part, comprising:
a first assembly; and
a second assembly;
wherein the first and second assemblies may be joined in a predefined final position using ultrasonic welding;
wherein the housing part includes at least one pin on one of the first and second assemblies and at least one receptacle part on the other of the first and second assemblies, the at least one receptacle part having a shape substantially complimentary to the at least one pin when joined in the predefined final position; and
wherein the housing part includes at least one rib on one of the first and second assemblies and at least one grooved part on the other of the first and second assemblies, the at least one grooved part having a shape substantially complimentary to the at least one rib when joined in the predefined final position.

22. A housing part as claimed in claim 21, wherein the housing part is formed as a faceplate for a mobile telecommunication device.

23. An apparatus for manufacturing a housing part, wherein the housing part includes first and second assemblies, comprising parts for joining together the first and second assemblies in a predefined final position using ultrasonic welding, wherein the housing part includes at least one pin on one of the first and second assemblies and at least one receptacle part on the other of the first and second assemblies, the at least one receptacle part having a shape substantially complimentary to the at least one pin when joined in the predefined final position, and wherein the housing part includes at least one rib on one of the first and second assemblies and at least one grooved part on the other of the first and second assemblies, the at least one grooved part having a shape substantially complimentary to the at least one rib when joined in the predefined final position.

24. An apparatus for manufacturing a housing part as claimed in claim 23, wherein the housing part is formed as a faceplate for a mobile telecommunication device.

25. A method for manufacturing a housing part, the method comprising:
forming a first assembly;
forming a second assembly; and
joining together the first and second assemblies in a predefined final position using ultrasonic welding;
wherein the housing part includes at least one pin on one of the first and second assemblies and at least one receptacle part on the other of the first and second assemblies, the at least one receptacle part having a shape substantially complimentary to the at least one pin when joined in the predefined final position; and
wherein the housing part includes at least one rib on one of the first and second assemblies and at least one grooved part on the other of the first and second assemblies, the at least one grooved part having a shape substantially complimentary to the at least one rib when joined in the predefined final position.

26. A method for manufacturing a housing part as claimed in claim 25, wherein the housing part is formed as a faceplate for a mobile telecommunication device.

27. A ultrasonic welding facility for use in manufacturing a housing assembly, comprising:
an ultrasound source;
an anvil for holding the housing assembly; and
a sonotrode for injecting ultrasound from the ultrasound source into the housing assembly, wherein the sonotrode is constructed such that a contour of a surface of the sonotrode which is in contact with the housing assembly during ultrasonic welding substantially corresponds with a contour of an area of the housing assembly being ultrasonically welded.

28. A ultrasonic welding facility as claimed in claim 27, wherein the housing assembly is a faceplate for a mobile telecommunication device.
